(19) United States
(12) Patent Application Publication
(10) Pub. No.: US 2016/0341188 A1
(43) Pub. Date: Nov. 24, 2016

(54) A COMPRESSED NATURAL GAS SYSTEM AND METHOD

(71) Applicant: NUOVO PIGNONE SRL, Florence (IT)

(72) Inventors: Leonardo TOGNARELLI, Florence (IT); Marco SANTINI, Florence (IT); Francesco BUFFA, Florence (IT)

(21) Appl. No.: 15/114,142

(22) PCT Filed: Jan. 30, 2015
(86) PCT No.: PCT/EP2015/051908

§ 371 Date: Jul. 26, 2016

(30) Foreign Application Priority Data
Jan. 31, 2014 (IT) FI2014A000021

(51) Int. Cl. F04B 35/06; F17C 5/06; F04B 41/02; F02G 1/043; F04B 37/18; F04B 39/00

(52) U.S. Cl. CPC F04B 35/06; F04B 37/18; F04B 39/0005; F04B 39/0094; F04B 41/02; F02G 1/043; F17C 5/06; F17C 2205/0323; F17C 2205/0341; F17C 2221/033; F17C 2227/0164; F17C 2250/01; F17C 2265/065; F17C 2265/063

(57) ABSTRACT

The CNG system comprises a gas inlet line and a reciprocating compressor arranged and configured for compressing gas from the gas inlet line and delivering compressed gas towards a dispenser. A Stirling engine is drivingly connected to the reciprocating compressor. A burner receives gas from the gas inlet line and generates thermal energy for powering the Stirling engine.

### FIELD OF THE INVENTION

The present disclosure relates in general to a system and method for compressing gas. More specifically, the present disclosure relates to a system and method for dispensing compressed natural gas in a refueling station.

### BACKGROUND

Traditionally, internal combustion engines have been fueled by one or more distillates of fuel oil, such as gasoline or diesel. Gasoline or diesel is at atmospheric pressure during filling. Recently a growing number of vehicles have been manufactured, or converted, so their engines operate on natural gas instead of the longer chain hydrocarbons. The availability, low cost, and lower emissions of combusting natural gas over fuel oil distillates have garnered interest in continuing to increase the number of natural gas powered vehicles. Typically, natural gas fills a vehicle at a pressure exceeding 200 bar, which greatly exceeds the atmospheric pressure conditions of traditional fuels. The high filling pressure of natural gas requires compressing the natural gas prior to dispensing it to the vehicle. Thus while there are incentives to power vehicles with natural gas, obstacles exist in its delivery.

### BRIEF DESCRIPTION

According to one aspect, the present disclosure relates to a system for compressing a gas including a gas source, for instance a gas pipeline or a gas distribution grid, which can be connected to a gas inlet line for delivering gas to a reciprocating compressor. The reciprocating compressor is arranged and configured for compressing gas from the gas source and delivering compressed gas towards a utility. In some embodiments the utility can include a dispenser, for instance a dispenser for vehicle fueling. In some embodiments the utility can include a compressed-gas storage tank. A combination of compressed-gas storage tank(s) and one or more dispensers can be provided, gas being compressed by the reciprocating compressor and delivered to the storage tank and therefrom upon request to the dispenser, e.g. for vehicle re-fueling. The system further includes a Stirling engine drivingly connected to the reciprocating compressor. A burner receives gas from the gas source, and gas burned in the burner is used to provide thermal power to the Stirling engine for converting thermal power into mechanical power and driving the reciprocating compressor. The burner can be connected to the same gas supply line which supplies gas at the suction side of the reciprocating compressor. Gas treatment equipment, such as dryers, filters and the like can be provided for treating the gas from the gas source before feeding the gas to the gas burner and to the reciprocating compressor inlet.

A compressed gas station can thus be designed, which can be installed in any location where a source of hydrocarbon gas is available, e.g. a gas pipeline. The gas is used as a source of energy for operating a gas compressor and dispensing compressed gas to a dispenser, for example for fueling a vehicle. The Stirling engine provides efficient power conversion to operate the compressor, and can easily be operated with a minimum or virtually no maintenance. Gas can e.g. be diverted from a gas pipeline and delivered partly to the burner for generating thermal energy powering the Stirling engine, and partly to the reciprocating compressor. This latter compresses the gas and delivers compressed gas to the compressed-gas storage tank and/or the dispenser, for example for vehicle fuelling purposes.

According to a further aspect, the disclosure concerns a method of supplying compressed gas, e.g. hydrocarbon gas. The method includes providing a supply of hydrocarbon gas; providing a reciprocating compressor; connecting the reciprocating compressor to the supply of hydrocarbon gas; providing a Stirling engine drivingly connected to the reciprocating compressor; generating thermal power by burning hydrocarbon gas from the supply; at least partly converting the thermal power into mechanical power in the Stirling engine; driving the reciprocating compressor with mechanical power generated by the Stirling engine; compressing hydrocarbon gas from the supply in the reciprocating compressor; and delivering the compressed hydrocarbon gas to a utility, e.g. a dispenser and/or a compressed-storage tank in turn connected to a dispenser.

Features and embodiments are disclosed here below and are further set forth in the appended claims, which form an integral part of the present description. The above brief description sets forth features of the various embodiments of the present invention in order that the detailed description that follows may be better understood and in order that the present contributions to the art may be better appreciated. There are, of course, other features of the invention that will be described hereinafter and which will be set forth in the appended claims. In this respect, before explaining several embodiments of the invention in details, it is understood that the various embodiments of the invention are not limited in their application to the details of the construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which the disclosure is based, may readily be utilized as a basis for designing other structures, methods, and/or systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

A more complete appreciation of the disclosed embodiments of the invention and many of the attendant advantages thereof will be readily obtained as the same becomes better understood by reference to the following detailed description when considered in connection with the accompanying drawings, wherein:

FIG. 1 schematically illustrates a CNG refueling station with a reciprocating compressor driven by a Stirling engine;

FIG. 2 illustrates a cross-sectional view of a Stirling engine in the “alpha” configuration, for driving the reciprocating compressor of a CNG refueling station; and

FIG. 3 schematically illustrates an arrangement of a reciprocating compressor driven by a free-piston Stirling engine arrangement.

### DETAILED DESCRIPTION

The following detailed description of the exemplary embodiments refers to the accompanying drawings. The same reference numbers in different drawings identify the same or similar elements. Additionally, the drawings are not necessarily drawn to scale. Also, the following detailed description does not limit the invention. Instead, the scope of the invention is defined by the appended claims.

Reference throughout the specification to “one embodiment” or “an embodiment” or “some embodiments” means that the particular feature, structure or characteristic described in connection with an embodiment is included in at least one embodiment of the subject matter disclosed. Thus, the appearance of the phrase “in one embodiment” or “in an embodiment” or “in some embodiments” in various places throughout the specification is not necessarily referring to the same embodiment(s). Further, the particular features, structures or characteristics may be combined in any suitable manner in one or more embodiments.

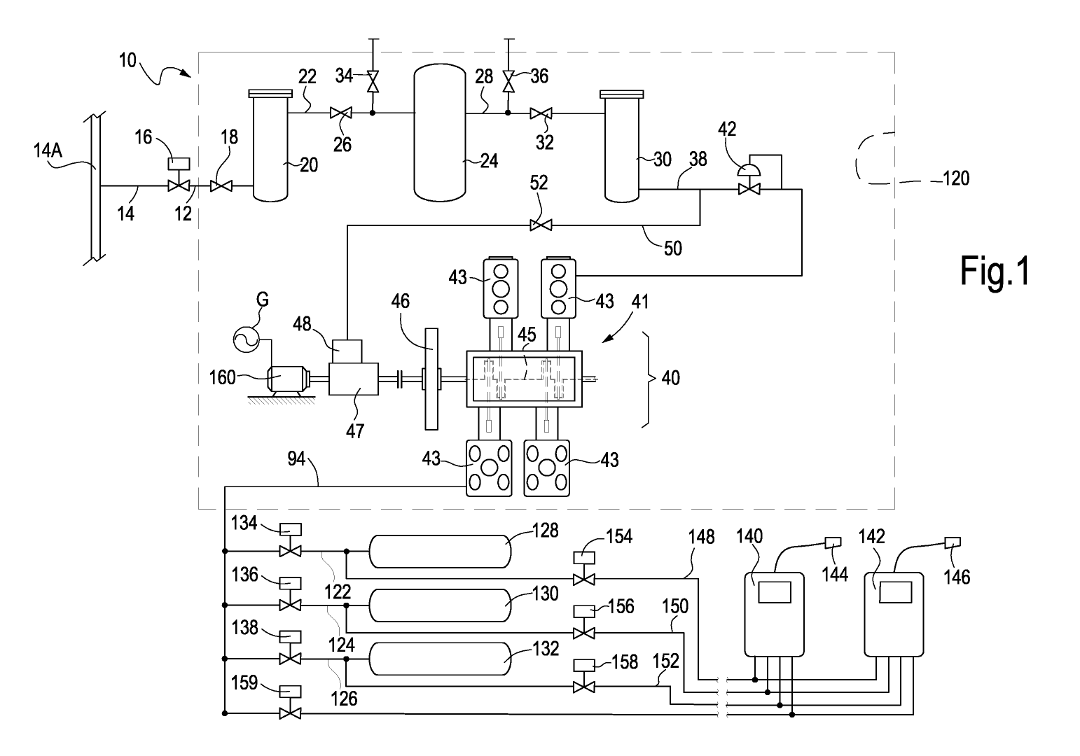

FIG. 1 is a schematic illustration of a compressed natural gas (CNG) system 10 shown having an inlet line 12 for delivering gas to the CNG system 10. The inlet line 12 attaches to a supply line 14; which in an example is in communication with a natural gas pipeline 14A or a natural gas utility distribution system that distributes natural gas to residential and commercial customers of natural gas, and operates at example pressures of from about 0.03 bar to about 14 bar. Alternatively, the supply line 14 can be in communication with a transmission line and having example operating pressures of from about 14 bar to about 105 bar. Example gases include hydrocarbons that are a gas at standard temperature and pressure, such as but not limited to methane, ethane, propane, butane, and mixtures thereof

In an example, the hydrocarbons can be saturated or unsaturated, and the gas can include trace amounts of non-hydrocarbons, such as nitrogen, hydrogen, oxygen, sulfur. A shut-off valve 16, which may optionally be automated or manual, is shown at the connection between the inlet line 12 and supply line 14 for selectively blocking communication between the inlet line 12 and supply line 14. Optionally, an additional valve 18 may be provided in the inlet line 12 downstream of valve 16. Inlet line 12 terminates at a filter 20, which may be used for removing particles and other non-desirable matter from within a stream of gas flowing within the inlet line 12. Filter 20 connects via line 22 to a dryer 24, which may include a desiccant for removing moisture from the gas stream.

Optionally, dryer 24 can be empty and provide an open space to operate as a knockout drum thereby removing moisture by gravity separation. Valve 26 is disposed in line 22 for selectively blocking flow between filter 20 and dryer 24. An outlet line 28 connects dryer 24 to a second filter 30 for additional filtering downstream of the dryer 24. Valve 32 is shown in line 28 and selectively blocks communication between dryer 24 and filter 30. Optional regeneration lines 34, 36 are shown connecting respectively to line 22 and line 28 between the dryer 24 and valves 26, 32. Desiccant in the dryer 24 can be regenerated by closing valves 26, 32 to isolate dryer 24, opening valves in regeneration lines 34, 36, and circulating a hot and/or dry gas through regeneration lines 34, 36 and dryer 24. A line 38 connects to filter 30 on one end and to a compressor package 40 on another for transmitting gas from the filter 30 to be compressed within the compressor package 40. A pressure control valve 42 is shown in line 38 for controlling the flow of gas within line 38.

The example compressor package 40 of FIG. 1 is shown having a multistage reciprocating compressor 41. In the exemplary embodiment of FIG. 1 reciprocating compressor 41 includes four stages, each including a cylinder 43, housing a reciprocatingly moving piston, slidingly arranged therein, driven by crankshaft 45 powered by compressor driver 47. Reciprocating compressor 41 can further include a flywheel 46. Intercoolers, or interstage coolers (not shown) can be provided between two sequentially arranged cylinders of reciprocating compressor 41, to reduce the temperature and increase the density of the compressed gas delivered by the upstream stage towards the downstream stage. Reciprocating compressor 41 can be a double-effect compressor, including a cross-head and a piston rod for each piston slidingly housed in a respective cylinder 43. Each cross-head is connected to crankshaft 45 by a tie rod.

An exit line 94 connects the last compressor cylinder and provides a transmission line for discharging compressed gas from the compressor package 40. Thus, in one example, the compressor package 40 receives gas at about the pressure in the supply line 14 and compresses the gas to pressures in excess of about 210 bar, and alternatively to pressures in excess of about 250 bar. Optionally, the discharge pressure in exit line 94 can be in excess of about 300 bar, and alternatively to pressures in excess of about 400 bar. Compressors for use with the method and system described herein are not limited to four stage compressors. Alternative embodiments exist wherein the gas is compressed with a compressor having, one stage, two stages, three stages, five stages, or more than five stages. Also, in further embodiments, more than one reciprocating compressor can be provided, each driven by a respective compressor driver 47.

Still referring to FIG. 1, the filters 20, 30, dryer 24, and compressor package 40 are schematically illustrated as being within container 120, wherein valve 18 is disposed just inside of container 120. As known for instance from WO 2013/134344, the content whereof is incorporated herein by reference, example containers may include those manufactured to an international standards organization (ISO) and more specifically to ISO standard 6346. In an embodiment, a standardized container housing the CNG system 10, after the CNG system 10 is installed in the container 120, can be readily transported with its contents as a single modular unit. This is because most shippers of freight use vehicles (e.g. trains, tractor trailer rigs, cargo ships) equipped to receive and stow a standardized shipping container. Moreover, attachment points provided on a readily available ISO container enable them to be safely secured in or on a shipping vehicle.

The CNG system 10 of FIG. 1 further includes lines 122, 124, 126 that branch from a portion of exit line 94 downstream of the compressor package 40. Lines 122, 124, 126 respectively connect to an inlet of compressed-gas storage tanks 128, 130, 132. Although three storage tanks 128, 130, 132 are illustrated, embodiments exist of the CNG system 10 disclosed herein having zero, one, two, four, and more than four storage tanks. Schematically shown in FIG. 1, the storage tanks 128, 130, 132 are substantially elongate and cylindrical members that in one example are arranged in parallel and for instance mounted on an upper surface of container 120. In an alternative arrangement, the tanks 128, 130, 132 can be provided on side or lower surfaces of the container 120, or separate from the container 120, such as at grade. Valves 134, 136, 138 are respectively provided in lines 122, 124, 126 and are for selectively regulating flow to tanks 128, 130, 132.

Gas compressed in CNG system 10 can be accessible to end users of the compressed gas via dispensers 140, 142. Nozzles 144, 146 on dispensers 140, 142 provide a flow path for gas compressed in the CNG system 10 to a vehicle (not shown) or other storage vessel for compressed gas purchased by a consumer. Thus, dispensers 140, 142 may be equipped with card readers or other payment facilities so that a consumer may purchase an amount of compressed gas at the dispensers 140, 142. Although two dispensers 140, 142 are shown, the CNG system 10 can have one, three, or more than three dispensers.

Lines 94, 148, 150, 152 provide example flow paths between the CNG system 10 and dispensers 140, 142. In the example of FIG. 1, lines 148, 150, 152 have an inlet end connected to lines 122, 124, 126 and downstream of valves 134, 136, 138. Valves 154, 156, 158 are provided respectively in lines 148, 150, 152; selective opening and closing of valves 154, 156, 158 in combination with selective opening and closing of valves 134, 136, 138, 159 selectively deliver compressed gas to storage tanks 128, 130, 132 or directly to dispensers 140, 142. Optionally, gas stored within tanks 128, 130, 132 can be selectively delivered through one of lines 148, 150, 152 by the closing of valves 154, 156, 158. In one example, compressed gas can flow directly from the compressor package 40 through exit line 94 to the dispensers 140, 142. In this example, valve 159 in line 94 is open to allow flow through exit line 94.

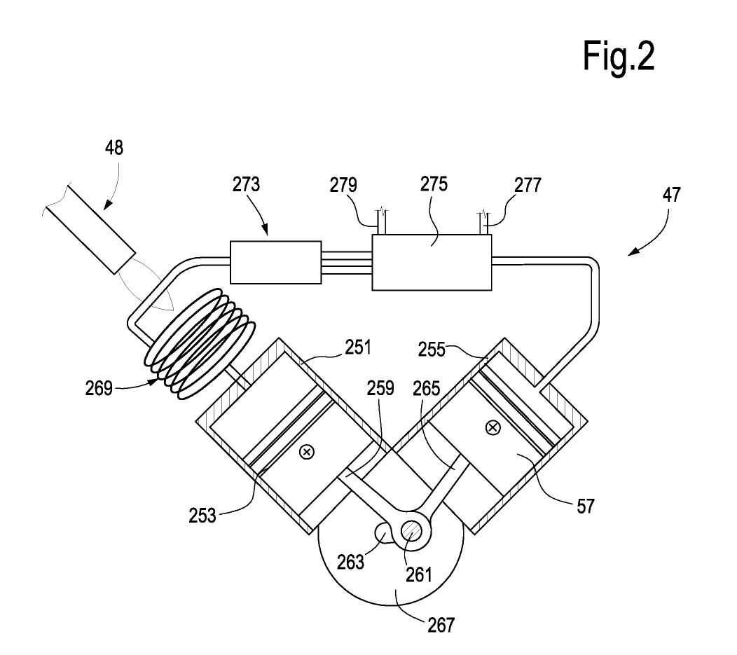

As mentioned, compressor driver 47 of compressor package 40 includes a Stirling engine. The Stirling engine can be of any known configuration. According to some embodiments Stirling engine 47 is of the α-type, as illustrated in FIG. 2 and described in greater detail here below. In other embodiments, not shown, Stirling engine 47 can be a β-type or a γ-type Stirling engine.

Referring to FIG. 2, a Stirling engine 47 of the so called α-type includes a first cylinder 251, wherein a first piston 253 is slidingly movable. A second cylinder 255 is further provided, oriented at e.g. 90° with respect to the cylinder 251. A second piston 257 is slidingly arranged in the second cylinder 255.

A first connecting rod 259 connects the first piston 253 to a crank pin 261 forming part of an output 263. A second connecting rod 265 connects the second piston 257 to the same output 263. A flywheel 267 can be mounted on the output shaft 63.

The Stirling engine 47 can include a hot end with a heater 269 which receives heat from the burner 48. The heater is in flow communication with the interior of the first cylinder 251. A flow path connects the heater 269 to a regenerator 273, a cooler 275 and the interior of the second cylinder 255. The cooler 275 can be in thermal contact with a cold source or heat sink, and forms a cold end of the Stirling engine 47. The heat sink can be the ambient air. In some embodiments, a cooler with a cooling circuit, for example a water cooling circuit can be used as a heat sink. In FIG. 2 a cooling circuit is schematically represented by inlet and outlet manifolds 277 and 279.

The operation of the Stirling engine is known to those skilled in the art and will not be described in detail herein. In general terms, a working gas contained in the closed system formed by the inner volumes of cylinder-piston system 251, 253, cylinder-piston system 255-257, heater 269, regenerator 273, cooler 275 and relevant piping is subject to a thermal cycle including cyclic compression, heating, expansion and cooling. The thermodynamic cycle performed by the working gas in the Stirling engine 47 converts part of the thermal energy delivered by the thermal source 271 to the hot end of the Stirling engine into useful mechanical power available on the output shaft 263.

The α-type Stirling engine shown in FIG. 2 is only one of several possible configurations of Sterling engines. Other useful Sterling engine arrangements are of the β-type and γ-type of Stirling engines, which will not be described herein and which are known to those skilled in the art.

The various embodiments of the system disclosed herein can utilize an α-type Stirling engine 47 as schematically shown in FIG. 2, or else any other suitable Stirling engine configuration, suitable for converting thermal energy available from the thermal energy source or heat source 271 into mechanical power, which is used to drive the reciprocating compressor 1 and/or to produce electric power, as will be described here below.

The output shaft of Stirling engine 47 can be directly connected to crankshaft 45 of reciprocating compressor 41.

The hot end of Stirling engine 47 receives heat from a burner 48, where natural gas from supply line 14 is burned. The gas delivered to burner 48 can be taken upstream of the filter and drier arrangement 20, 24, 30. In some embodiments, gas is however taken from line 38, after filtering and drying. A gas diverting line 50 connects line 38 to burner 48. A valve 52 can be provided along diverting line 50, to shut down fuel delivery to the burner.

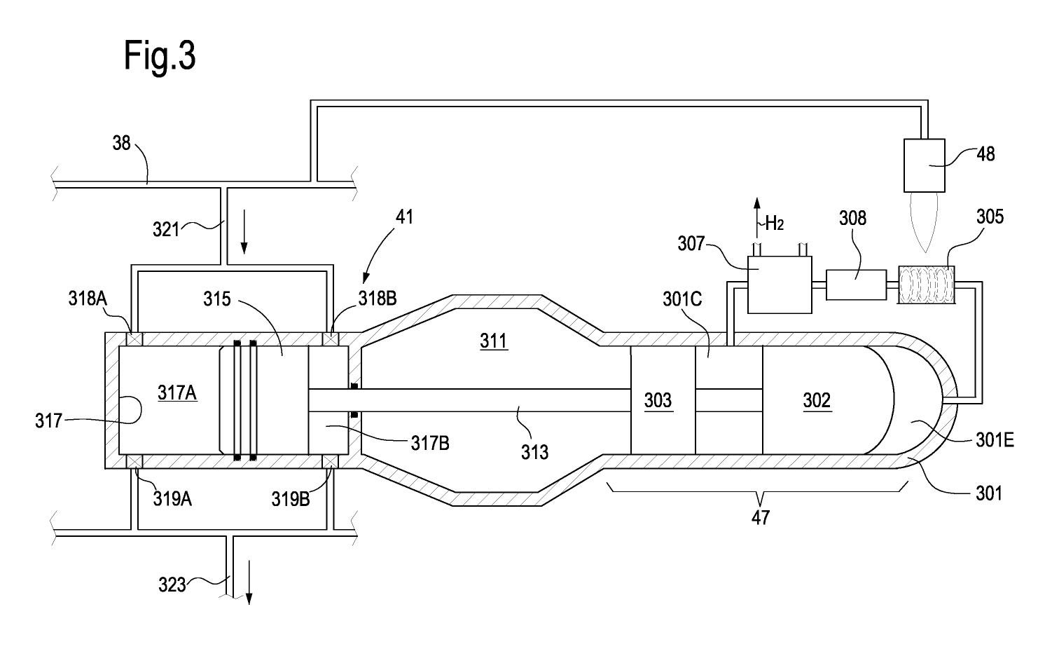

According to some embodiments, the compressor package can be designed so that the compressing piston of the compressor is directly acted upon by the working piston of a free-piston Stirling engine, thus avoiding a crankshaft. An embodiment using a free-piston Stirling engine of this kind for driving the reciprocating compressor of the CNG system 10 is illustrated in FIG. 3. The Stirling engine is labeled again 47 and the reciprocating compressor is labeled again 41. The Stirling engine 47 can include a cylinder 301 wherein a displacer 302 and a power piston 303 are slidingly arranged. The interior of the cylinder 301 is divided into an expansion chamber 301E at the hot end of the engine and into a compression chamber 301C at the cold end of the engine. A heater 305 and a cooler 307 are provided along a flow passage connecting the compression chamber and the expansion chamber 301E. A regenerator 308 is arranged between the heater 305 and the cooler 307. A bouncing volume or another resilient system, e.g. a set of springs, are provided to bias the power piston 303. Operation of the free-piston Stirling engine described so far is known and will not be described herein.

The power piston 303 can be directly connected with a piston rod 313 to a reciprocating piston 315 slidingly housed in a cylinder 317 of the reciprocating compressor 41. In some embodiments the reciprocating compressor 41 can be a double-effect compressor. The interior of the cylinder 317 can be divided by piston 314 into a first chamber 317A and a second chamber 317B. Each chamber 317A, 317B can be provided with at least one automatic suction valve 318A, 318B and one automatic discharge valve 319A, 319B. The suction valves 318A, 318B selectively connect the two chambers 317A, 317B with a suction duct 321 wherefrom low-pressure gas is sucked. The suction duct 321 can be connected e.g. to the gas supply line 38. The discharge valves 319A, 319B selectively connect the two chambers 317A, 317B with a discharge duct, which can be in direct or indirect fluid communication with one or more dispensers 140, 142 and/or with one or more storage tanks 128, 130, 132.

The gas supply line 38 also supplies gas to a burner 48 which provides heat to the hot end of the Stirling engine 47.

The free-piston Stirling engine provides a direct link between the power piston 303 of the engine and the reciprocating piston 315 of the reciprocating compressor 41, thus further simplifying the structure of the system.

Compressor package 40 and optional filter and dryer arrangement 20, 24, 30 can be arranged in a container for shipping or transportation, e.g. an ISO container. The storage tanks 128, 130, 132 can be mounted in or on the container or installed separately therefrom. A transportable modular compression system is thus obtained, which can easily be transported to a location having a supply of hydrocarbon gas and which can quickly be connected to the gas supply. The same gas which is compressed by the system is also used as a fuel to operate the Stirling engine. Need for an electric power distribution grid is avoided.

According to some embodiments, the Stirling engine can also be provided for driving an electric generator 160, for generating electric power available on a local electric power grid G. The electric power generated by electric generator 160 can be used to power auxiliaries of the system 10 and/or external additional users.

The use of an external combustion engine, such as a Stirling engine, rather than an internal combustion engine makes the compressor package more reliable and requiring virtually no maintenance. Among the potential benefits of a Stirling engine vs. an internal combustion engine the following are worth noting: limited or no need (depending upon the configuration of the Stirling engine) for lubrication oil, which reduces or eliminates the need of lubrication circuit topping-up, periodical oil and oil-filter replacement; no need for spark plugs, air filters, timing chains and other components of the timing system; no need for fuel injection systems; and consequent reduction of management and maintenance costs. This makes the system particularly suitable for use in locations which are difficult to reach e.g. by suppliers of spare parts.

In an embodiment, Stirling engines are moreover particularly useful in combination with a CNG reciprocating compressor as the rotational speed rate of a Stirling engine is substantially the same as the rotational speed of the reciprocating compressor and thus gearboxes can be avoided, which increases the overall efficiency of the system and the reliability thereof.

The reduced vibrations and noise of the Stirling engine vis-à-vis an internal combustion engine make the use thereof even more attractive.

While the disclosed embodiments of the subject matter described herein have been shown in the drawings and fully described above with particularity and detail in connection with several exemplary embodiments, it will be apparent to those of ordinary skill in the art that many modifications, changes, and omissions are possible without materially departing from the novel teachings, the principles and concepts set forth herein, and advantages of the subject matter recited in the appended claims. Hence, the proper scope of the disclosed innovations should be determined only by the broadest interpretation of the appended claims so as to encompass all such modifications, changes, and omissions. Different features, structures and instrumentalities of the various embodiments can be differently combined.

What is claimed is:

1. A system for compressing a gas comprising:
a gas source;
a reciprocating compressor arranged and configured for compressing gas from the gas source and delivering compressed gas towards a utility;
a Stirling engine drivingly connected to the reciprocating compressor; and
a burner configured to receive gas from the gas source, wherein gas is burned to provide thermal power to the Stirling engine, and the Stirling engine is configured to convert the thermal power into mechanical power for driving the reciprocating compressor.

2. The system of claim 1, wherein the gas source comprises at least one gas inlet line.

3. The system of claim 1, wherein the utility comprises at least one compressed-gas storage tank, wherein the gas compressed by the reciprocating compressor is stored in the storage tank.

4. The system of claim 1, wherein the utility comprises at least one gas dispenser.

5. The system of claim 1, wherein the utility comprises at least one compressed-gas storage tank and a gas dispenser, wherein the gas dispenser is connected with the compressed-gas storage tank.

6. The system of claim 5, wherein the dispenser is designed and configured for connection to a fuel tank of a vehicle.

7. The system of claim 1, further comprising a gas drying and filtering arrangement, wherein gas to be delivered to the burner is taken downstream of the drying and filtering arrangement.

8. The system of claim 7, wherein the gas source comprises at least one gas inlet line.

9. The system of claim 1, wherein the gas source comprises a gas pipeline.

10. The system of claim 1, wherein the gas source comprises a utility line that is in communication with a distribution system that supplies gas to residential and commercial customers.

11. The system of claim 1, further comprising an electric generator, driven by the Stirling engine.

12. The system of claim 1, wherein the Stirling engine and the compressor are arranged in a transportable container defining a modular compression system.

13. A method of supplying compressed hydrocarbon gas comprising:
providing a supply of gas;
providing a reciprocating compressor;
connecting the reciprocating compressor to the supply of gas;
providing a Stirling engine drivingly connected to the reciprocating compressor;
generating thermal power by burning gas from the supply;
at least partly converting the thermal power into mechanical power in the Stirling engine;
driving the reciprocating compressor with the mechanical power generated by the Stirling engine;
compressing gas from the supply in the reciprocating compressor; and
delivering the compressed gas to a utility.

14. The method of claim 13, further comprising the steps of:
providing an electric generator;
drivingly connecting the electric generator to the Stirling engine; and
converting the mechanical power generated by the Stirling engine into electric power with the electric generator.

15. The method of claim 13, wherein the utility comprises at least one compressed-gas storage tank.

16. The method of claim 13, wherein the utility comprises at least one gas dispenser.

17. The method of claim 16, further comprising the step of fueling a vehicle with compressed gas from the dispenser.

18. The method of claim 13, further comprising the steps of:
arranging the Stirling engine and the reciprocating compressor in a transportable container to define a modular compressed gas unit; and
transporting the modular compressed gas unit to a location proximate to the supply of gas.

19. The method of claim 13, wherein the supply of gas comprises at least one of a gas pipeline or a utility line in communication with a distribution system that supplies gas to residential and commercial customers.

20. The system of claim 12, wherein the transportable container is a standardized shipping container.
